(19) United States
(12) Patent Application Publication
(10) Pub. No.: US 2009/0222646 A1
(43) Pub. Date: Sep. 3, 2009

(54) METHOD AND APPARATUS FOR DETECTING PROCESSOR BEHAVIOR USING INSTRUCTION TRACE DATA

(75) Inventors: Nobuyuki Ohba, Miyagi-ken (JP); Kohji Takano, Tokyo (JP); Gang Zhang, Kanagawa-ken (JP)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/039,394

(22) Filed: Feb. 28, 2008

(51) Int. Cl. G06F 9/40

(52) U.S. Cl. 712/227; 712/E09.082

(57) ABSTRACT

A method and apparatus for detecting processor behavior in real time using instruction trace data, in one aspect, identifies one or more call addresses from which a function to be observed is called and establishes one or more end addresses of the function. Said one or more call addresses and said one or more end addresses are stored, and compared with a branch address contained in the instruction trace data to detect start and end of the function dynamically in real time.

### FIELD OF THE INVENTION

The present disclosure relates to obtaining processor behavior in real time using trace information in.

### BACKGROUND OF THE INVENTION

To monitor central processing unit (CPU) activities in real time, a trace function of a CPU can be used so that the CPU activity information can be acquired for each CPU cycle. More specifically, a CPU has physical input/output (I/O) pins for outputting the trace information. By monitoring the details of the trace information from outside the CPU, the activity information of the CPU can be obtained. The trace information includes whether an instruction is executed or not, whether a branch is “taken” or “not taken”, and the branch address in every CPU cycle, i.e., information about an address to which a program branches. FIG. 1 illustrates a sample program and the trace information acquired by running the program.

A known method and its hardware system identify functions processed by a CPU in real time by monitoring trace information using an external monitoring apparatus. In this method, the external monitoring apparatus has the information as to which function is mapped to which logical address before running the program. Subsequently, the monitoring apparatus compares the branch address acquired from the trace information with the stored information so as to identify which function has been executed in real time. FIG. 2 illustrates the information about a memory space being used by a function stored in an existing monitoring apparatus and an existing method of identifying an executed function using the trace information. When the monitoring apparatus observes the top address to which a function is mapped, the monitoring apparatus recognizes that the function is called. Subsequently, when the monitoring apparatus observes an address in an area corresponding to the previously executed function, the monitoring apparatus recognizes that the currently executed function has just returned to the previously executed function.

In case of monitoring a large-scale program, not all the functions of the program are monitored. Instead, some pre-selected functions are monitored. To do so, the information as to when the functions of interest are started and ended is required. However, it is difficult to determine when the functions of interest are started and ended using only the memory spaces being used by these functions. This is because when a branch address outside the memory spaces being used by the functions of interest is observed, it cannot be determined whether the currently executed function calls a new function or it returns to the previously executed function. FIG. 3 illustrates this difficulty. Accordingly, even if the functions of interest are part of all the functions, the monitoring apparatus needs to know the ranges of the memory spaces being used by all of the functions. That is, the monitoring apparatus needs to store the ranges of the memory spaces being used by all of the functions in order to detect the start and end of the execution of each function of interest. Consequently, a large storage capacity is required.

As described above, there exists a method for observing the behavior of a CPU, for instance, an embedded CPU or otherwise, from trace information output from the CPU in debugging of the CPU. The trace information can include information indicating whether the CPU executed an instruction, information indicating whether a branch was taken or not taken, and information about an address to which a program branches (branch address). A CPU can output a specific address every time the branch is taken. Another type of CPU outputs a branch address only for a branch instruction whose branch address is unknown in a static program analysis and is determined at the execution thereof. An example of the second case is illustrated in FIGS. 4A and 4B. FIG. 4A shows a sample code and FIG. 4B shows retrievable trace information. To analyze how the program is executed from such trace information, a binary image of the program running at that time is necessary. This is because an unconditional jump instruction and a function call, whose branch destination is statically determined, do not provide trace information with their branch addresses, so that referring to both the binary image of the program and the trace information is required for reconstruction of the program execution flow.

Typically, trace information and a binary image of a program that can run in an embedded CPU are stored locally in a tracing PC, the trace information is measured, and then reconstruction and analysis are carried out using both the program binary image and the trace information. However, if it is necessary to identify a currently executed address in real time for, for example, real time verification, a process of storing trace information and then performing reconstruction cannot be used because it is not real time. To identify a currently executed address from trace information in real time by a measurement device, it is necessary for the measurement device to have a binary image similar to a program to be measured and to process obtained event information in real time. To this end, the measurement device needs to have the same size of a binary image as the program. This is impracticable because it needs significantly large capacity.

For debugging an embedded CPU, the information indicating when functions of interest started and terminated is helpful. In particular, for a design using a model driven architecture, in order to visualize how the model behaved, it is helpful to trace the model states. However, known measurement devices and methods need to have the full binary image to perform the reconstruction of the execution flow even if one wants to trace only specific functions. It is thus difficult to put such a technique to practical use.

### BRIEF SUMMARY OF THE INVENTION

A method and apparatus such as a circuit device for detecting processor behavior in real time using instruction trace data are provided. The method, in one aspect, may comprise determining a function of a module executing in a processor to be observed; identifying one or more call addresses from which the function is called; establishing one or more end addresses of the function to be a predetermined address increment of said one or more call addresses respectively; storing said one or more call addresses and said one or more end addresses; receiving instruction trace data; and comparing a branch address contained in the instruction trace data with said stored one or more call addresses and said one or more end addresses to detect start and end of the function dynamically in real time.

A circuit device for monitoring processor behavior using instruction trace data, in one aspect, may comprise, a program counter emulator operable to trace current execution address of a processor using trace information and store said current execution address; a mapping table operable to store information associated with a function to be observed; a return address table operable to store dynamically a return address of the function during execution; and a mapping table search unit operable to compare a value in the program counter emulator with one or more values in the mapping table and the return address table to detect start and end of the function, the circuit device operable to output information in real time as to whether the function starts or ends.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates a sample program and the trace information acquired by running the program.

FIG. 2 illustrates the information about a memory space being used by a function stored in an existing monitoring apparatus and an existing method of identifying an executed function using the trace information.

FIG. 3 illustrates examples of unidentifiable information resulting in using conventional monitoring apparatus.

FIG. 4A shows a sample code and FIG. 4B shows retrievable trace information.

FIG. 5A illustrates an example in which the start and end of a function of interest, FuncB, are detected.

FIG. 5B illustrates an example in which the start of the function of interest is detected, but the end of the function of interest is not detected.

FIG. 6 illustrates a procedure for acquiring the start address and the return addresses.

FIG. 7 is a functional block diagram of a circuit of monitoring apparatus in one embodiment of the present disclosure.

FIG. 8 illustrates the operation of the circuit of FIG. 7 in detail in one embodiment.

FIG. 9 is a flow diagram illustrating a method of obtaining a partial binary image after a function of interest is determined.

FIG. 10 illustrates an example of a derived partial binary image when the function of interest is “Function B” in the sample code illustrated in FIG. 4A.

FIG. 11 is a flow diagram illustrating processing performed by a circuit of the present disclosure in one embodiment.

FIG. 12 illustrates a circuit configuration according to the present disclosure in one embodiment.

### DETAILED DESCRIPTION

A method and apparatus of the present disclosure in one embodiment obtains function transition of a target of measurement, that is, behavior of the CPU to be monitored in real time by using only trace information of the target of measurement as input. Since the function transition is restored based on the trace information, no change is required in a source code of the target of measurement in order to obtain the function transition. For instance, code for debugging need not be inserted.

Several embodiments to the method and apparatus of the present disclosure are provided to overcome the shortcomings of the known methodology and devices. In one embodiment, rather than using the ranges of the memory space being used by the functions, the start and end of the execution of each function of interest are detected by using the start address of the function of interest and a table of the return addresses. The start address and the return addresses of the function may be determined by a static analysis. The ranges of the memory spaces of all the functions need not be stored; instead only the start address and return addresses of the function of interest are stored. The table does not have to have all the address ranges of the functions that are expected to run. Therefore, the storage capacity can significantly be decreased.

The existing method is described in more detail first. The monitoring apparatus stores the ranges of the memory spaces of all of the functions in order to detect the start and end of a function by monitoring the transition of an execution address in the memory spaces of the functions and tracing the start and end of a function. Let B denote a function of interest. Then, in order to detect the start and end of Function B, Function A that calls Function B is identified. Thereafter, the transition from Function A to Function B needs to be detected.

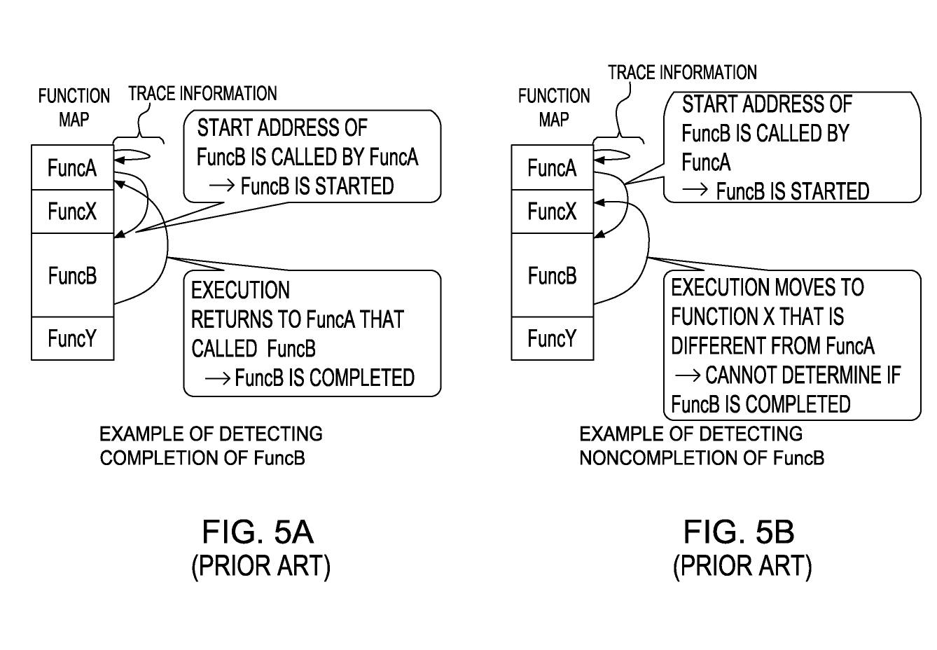

FIGS. 5A and 5B illustrate a particular example. FIG. 5A illustrates an example in which the start and end of a function of interest, FuncB, are detected. The start of FuncB is detected by capturing the program execution moving from FuncA to the top address of FuncB. The end of FuncB is detected by capturing the program execution moving from FuncB back to FuncA that called FuncB.

In contrast, FIG. 5B illustrates an example in which the start of the function of interest is detected, but the end of the function of interest is not detected. As in the example shown in FIG. 5A, the start of FuncB is detected when the program execution moves from FuncA to the top address of FuncB. However, since the function to which the process of FuncB moves is not FuncA that called FuncB, it cannot be determined if FuncB is completed. As noted above, to detect the start and end of the function using the transition between functions, the memory spaces not only of the function of interest but also of all the functions need to be recorded and managed. In other words, even if the function of interest is only FuncB, the information about the function maps of all the other functions needs to be prepared in order to detect the start and end of FuncB.

The method of the present disclosure in one embodiment acquires the end of the function of interest from the trace information. In one embodiment, the method does not detect the end of the function using the information about the memory space to which the function of interest is mapped. Instead, it detects the end of the function using the return address appearing when the function of interest is ended. That is, in place of using information about the memory space of a function, the start and end of the function of interest are detected by using the top address and the return address of the function of interest in the trace information.

TABLE 1

| Function | | | |
|---|---|---|---|
| Name | Function Identifier (ID) | Start Addresses | Return Address |
| FunctionB | 3 | 0x1100 | 0x1010 |

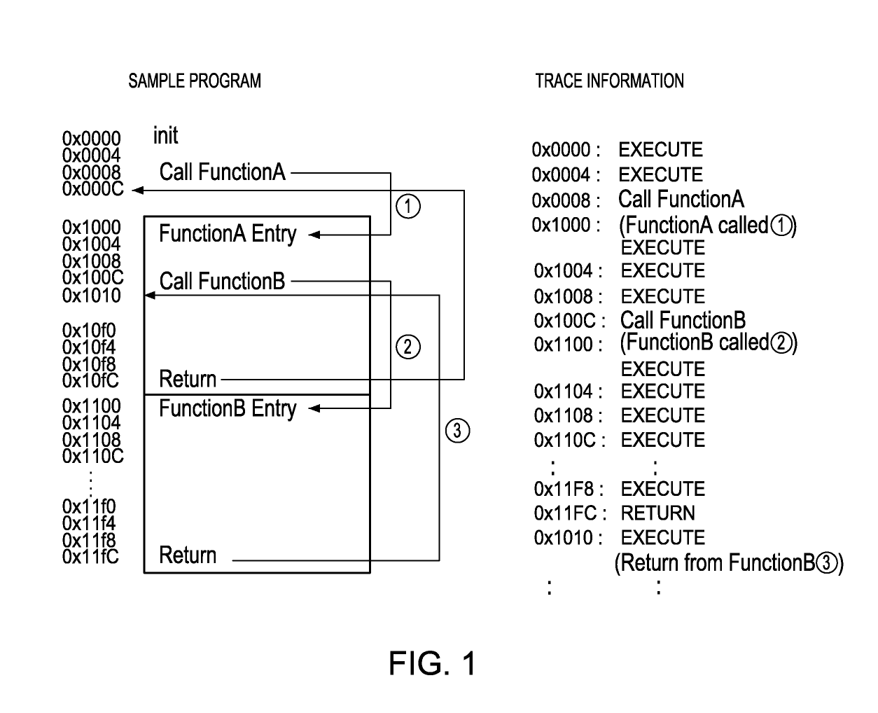

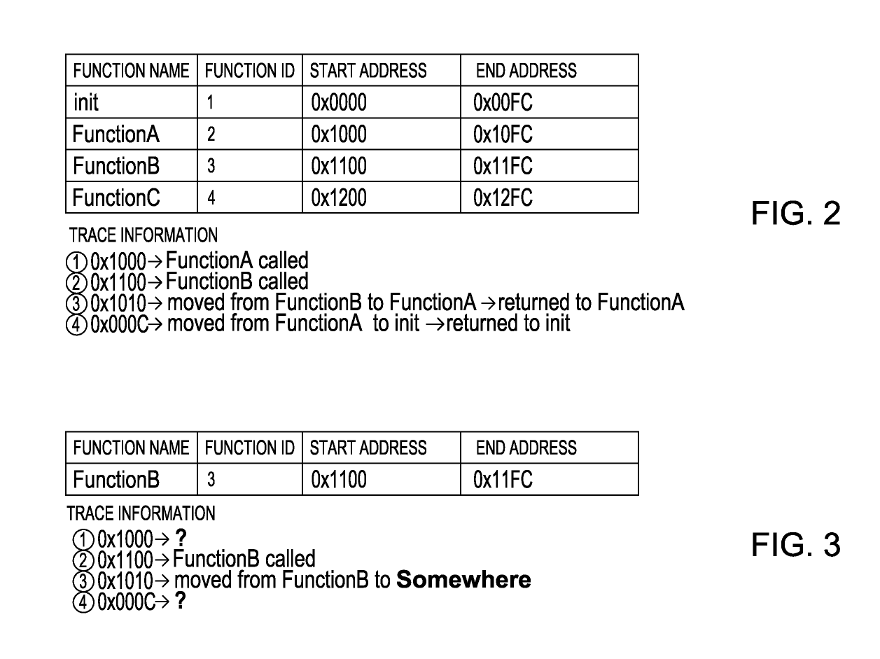

Table I illustrates an example of the information that a monitoring apparatus has, when it detects the function of interest, FuncB, being called in the example shown in FIG. 1. By using the table, the monitoring apparatus determines that the function of interest starts if the execution address acquired from the trace information matches the start address of the function of interest. In addition, the monitoring apparatus determines that the function of interest ends if the execution address acquired from the trace information matches the return address of the function of interest.

In such a method, if the function of interest is called by a plurality of functions, two or more return addresses equal to the number of the call points are stored in the table. However, if the function of interest is called by only one function, the number of entries remains one.

Model-driven design methodologies have become popular. Rational RoseRT is one of the tools that support model-driven design methodologies, and it is capable of automatic C/C++code generation. The generated code is ready to run on an actual system. State transitions in the model can be traced by monitoring function transitions presented in this disclosure. State transitions in the C/C++ code generated by RoseRT are usually implemented with function call schemes, in which a function is called by only one function. Consequently, the method of the present disclosure is suitable for the model-driven design.

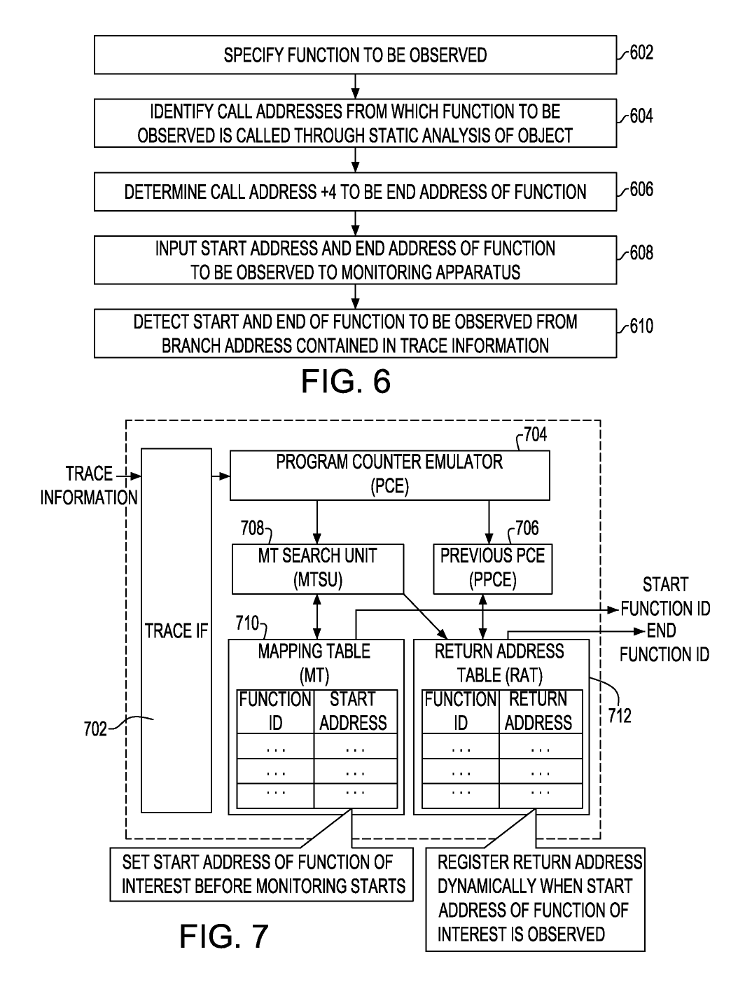

A procedure for acquiring the start address and the return addresses according to this method is described with reference to FIG. 6. At 602, a function of interest is selected. At 604, functions that call the function of interest are identified by the static analysis of the source code and the objects. To do so, the addresses of instructions that call the function of interest are searched in the code. The return addresses of the function of interest are the addresses next to these addresses, for instance, sequentially following those addresses. For instance, at 606, call address +4 is determined to be the end address of function. At 608, the start address and return addresses are stored in a monitoring apparatus. A monitoring apparatus may be software or hardware, or both combined. In the software implementation, the start and end addresses are stored in a memory, and compared with the branch addresses by an independent processor in the monitoring apparatus. In the hardware implementation, the addresses are stored in a memory in the same way, but compared by dedicated hardware. The MT Search Unit in FIG. 7 has a similar functionality. Thereafter, the device to be monitored, for instance, the CPU to be monitored, is started in order to obtain the trace information. At 610, by comparing an execution address acquired from the branch information contained in the trace information with each of the addresses in the generated table, the start and end of the function of interest can be detected. That is, if the branch information equals the addresses in the generated table, it can be detected that execution entered and exited the function of interest.

In another embodiment, the return addresses of the function of interest are found by statically analyzing the source code and the execution object in advance according to above first embodiment. Thereafter, the return addresses are stored in the table of the monitoring apparatus. However, an execution address at a time when a branch is taken can be detected by using the branch information contained in the trace information and the instruction execution information. If the branch address and the execution address have been acquired and a jump to one of the function of interest is observed, the return address is determined to be the address next to the address of the branch operation. Accordingly, by providing a mechanism to dynamically add a return address to the monitoring apparatus, the same advantage as that of the first embodiment can be obtained without storing the return addresses in a table before the program execution. Yet another embodiment provides a circuit configuration and a method for achieving the above-described technique.

The trace information may fall in the following two categories: 1) an instruction execution address and 2) the information as to whether or not the CPU executes the instruction. When address n is observed as the address of the instruction to be executed, and the instruction is reported as actually being executed or have been executed, the address of the instruction that follows the executed instruction is next to address n. That is, by tracing the address currently executed using the trace information, the monitoring apparatus can identify the currently executed address at any time.

When the monitoring apparatus observes the start address of the function of interest, the monitoring apparatus detects or monitors the address of the caller. The return address is the address next to the address of the instruction that called the function of interest. Accordingly, the return address, which is identified through the static analysis in the embodiment shown with reference to FIG. 6 can be dynamically obtained during execution by using a circuit of the monitoring apparatus. The monitoring apparatus thus may include a circuit for dynamically determining the return address and storing it in a table. By using the stored return addresses of the function of interest, the end of the function of interest can be detected.

FIG. 7 is a functional block diagram of a circuit of monitoring apparatus used in one embodiment of the present disclosure. The Trace IF 702 is a circuit that receives trace information of a CPU to be monitored and determines the execution address and information as to whether or not the CPU executes the instruction. A program counter emulator 704 traces the current execution address of the CPU by referring to the acquired trace information. More specifically, when the program counter emulator 704 acquires information about the execution address from the trace information, the program counter emulator 704 directly stores the address. When the program counter emulator 704 detects that the CPU executed an instruction, the program counter emulator 704 updates an address value thereof to the next address. Previous PCE (PPCE) block 706 represents a value of the address used in the last function call. This value is necessary for computing the return address. The role of the PPCE block 706 is described in more detail below.

Mapping Table (MT) 710 stores the identifier of the function of interest and the start address of the function of interest. This table 710 may be set by analyzing the source code before the program execution. Return Address Table (RAT) 712 is used for dynamically storing the return addresses of the functions of interest that is observed during execution.

By comparing the values in the two tables with the value of the PCE, the start and end of the function of interest can be detected. This detection is performed by MT Search Unit (MTSU) 708. If either of the start or end of the function of interest is detected, the circuit outputs information as to whether the function of interest starts or ends together with the ID of the function of interest.

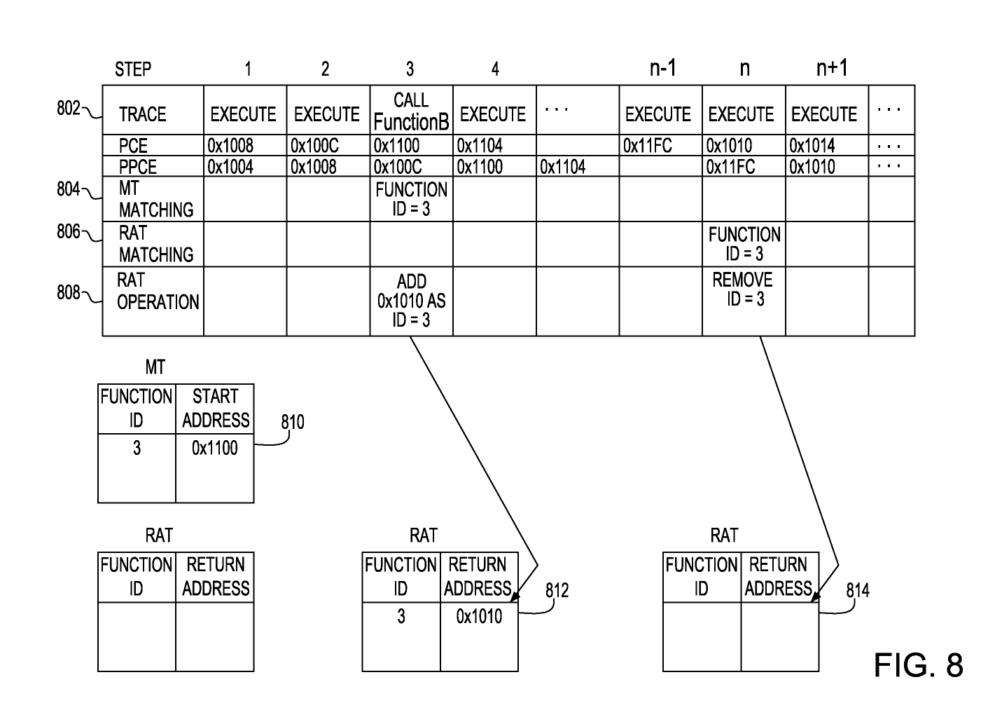

FIG. 8 illustrates the operation of the circuit of FIG. 7 in detail. In FIG. 8, entries in the row 802 titled “Trace” indicate information acquired from the trace information. A value “Execute” indicates that the CPU executed an instruction. This information does not contain the address information. Values “Call FunctionB” and “Return” include the address information in the trace information, since the branch address is noncontiguous. Entries in the row 804 titled “MT Matching” indicate the result of determination made by the MTSU as to whether an address that is the same as the PCE value is found in the MT. If the same address is found in the MT, the function ID is written into the entry. Similarly, entries in the row 806 titled “RAT Matching” indicate the result of determination as to whether an address that is the same as the PCE value is found in the RAT. Entries in the last row 808 titled “RAT Operation” indicate an operation for the table RAT.

The flow of the execution is described next. In Step 1, the trace information is “Execute”. Therefore, after this instruction is executed, the execution address moves to the next address 0x1008. The subsequent trace operation is described in the figure. In Step 2, since the trace information is “Execute”, the PCE is changed to the next address (0x100C). At that time, the PPCE holds the immediately previous PCE value (i.e., 0x1008). In Step 3, the CPU calls FunctionB, which is a function of interest. A branch address 0x1100 can be obtained from the trace information. Accordingly, the address information “0x1100” is stored in the PCE. The immediately previous PCE value 0x100C is stored in the PPCE. As shown at 810, 0x1100 was set in the MT before the monitoring operation starts. Accordingly, it is determined that the function represents the function of interest. Therefore, a return address is dynamically set in the RAT as shown at 812. The value of the return address is an address 0x100C+4 (=0x1010) at which the instruction next to the instruction indicated by the PPCE is stored. In this example, it is assumed that the CALL instruction of the target CPU is four bytes (32 bits) in size, and hence “+4” for the value of the return address.

Subsequently, the processes in steps 4 to n−1 are performed. In Step n, a branch operation indicated by “Return” is observed. In the case of “Return”, a branch address can be retrieved from the trace information. In this example, the branch address is 0x1010. Since this value 0x1010 is equal to the return address stored in the RAT, the end of the function of interest is detected. Immediately after the end of the function of interest is detected, the corresponding entry value in the RAT is erased. In one embodiment, the RAT behaves like a stack memory. The entry for the returned function is no longer needed, and therefore erased. A function will be called from two or more functions and thus the entry information is maintained on the fly. As described in the foregoing procedure, by dynamically generating and erasing the return address of the function of interest, the start and end of the function of interest can be detected.

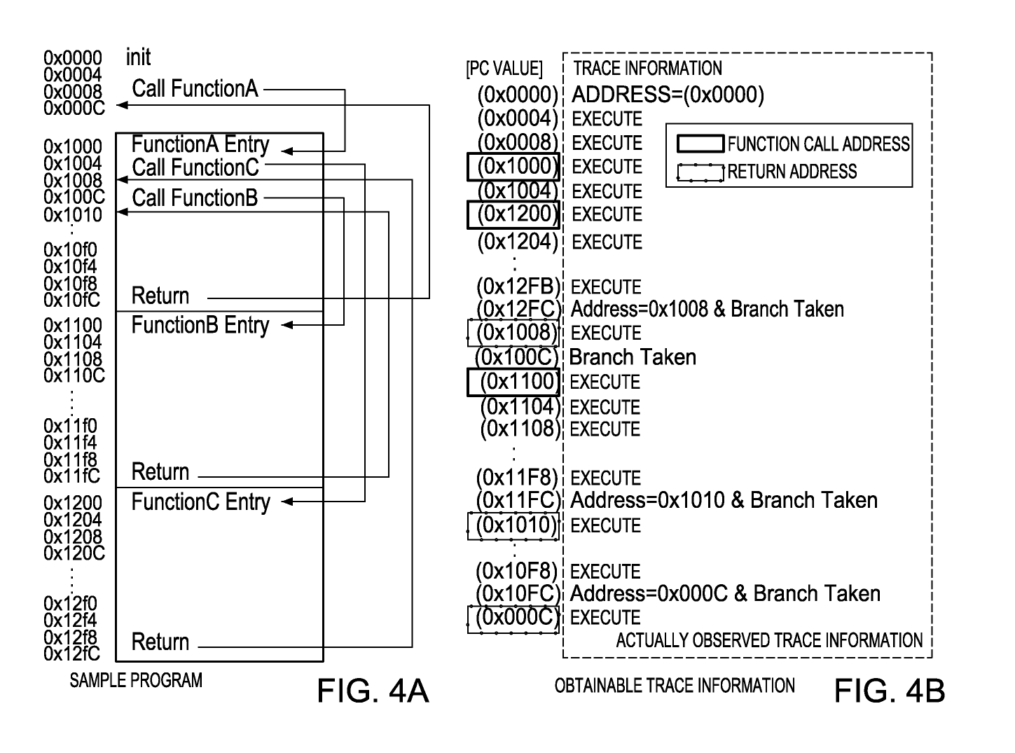

It is noted that in the RiscTrace tracing system, when the CPU executes a CALL instruction, it does not output the jump target address to the trace port. The CPU only generates “Execute” information, as shown in FIG. 4B. For this reason, the binary image needs to be analyzed to know the target address. The conventional tracer has the full binary image so that it can identify which address the CPU jumps to by constantly referring to the binary data. The method and system of the present disclosure in one embodiment, however, uses the trace address data, which is generated by a RETURN instruction, to identify the current instruction address. Assume that Function A calls Function B. When Function B returns to Function A, the return target address in Function A is generated and output to the trace port. By monitoring this address, the method and system of the present disclosure in one embodiment can know Function A's address and then retrieve the part of binary image contained in Function A. From this point, the CALL instruction target can be identified by analyzing the binary data. If it is desired to detect a function of interest [X], the method and system of the present disclosure in one embodiment trace from the previous RETURN instruction to identify the start address of function of interest [X]. The previous RETURN instruction will be executed in any function calls just before the call of function of interest [X]. In order to detect any function calls just before the call of X, the method and system of the present disclosure in one embodiment detect another function [F] that calls the function X at 904.

Yet in another embodiment, a technique is provided for identifying a function call immediately before a call of a function of interest by static analysis of source code, storing only a binary image from a return point of the immediately preceding function call to the call of the function of interest in a measurement device, and using the stored binary image to carry out reconstruction for tracing. The amount of code stored for reconstruction is reduced by selectively recording the functions of interest and the functions that call them. The size of the capacity can be further reduced by storing only an instruction that affects an address (a branch, a function call) from a partially held binary image. Still yet, a circuit that enables dynamically reconstructing an address of a function of interest using the partial binary image is provided.

The method and apparatus in one embodiment identify a portion that calls a function of interest and additionally, identify a function call immediately before the function of interest is called. The method in one embodiment exploits a characteristic that a return address is obtainable as trace information because a branch for a return occurring after completion of a function has a dynamically determined address. The method and apparatus derives partial binary image for use in reconstruction of function of interest.

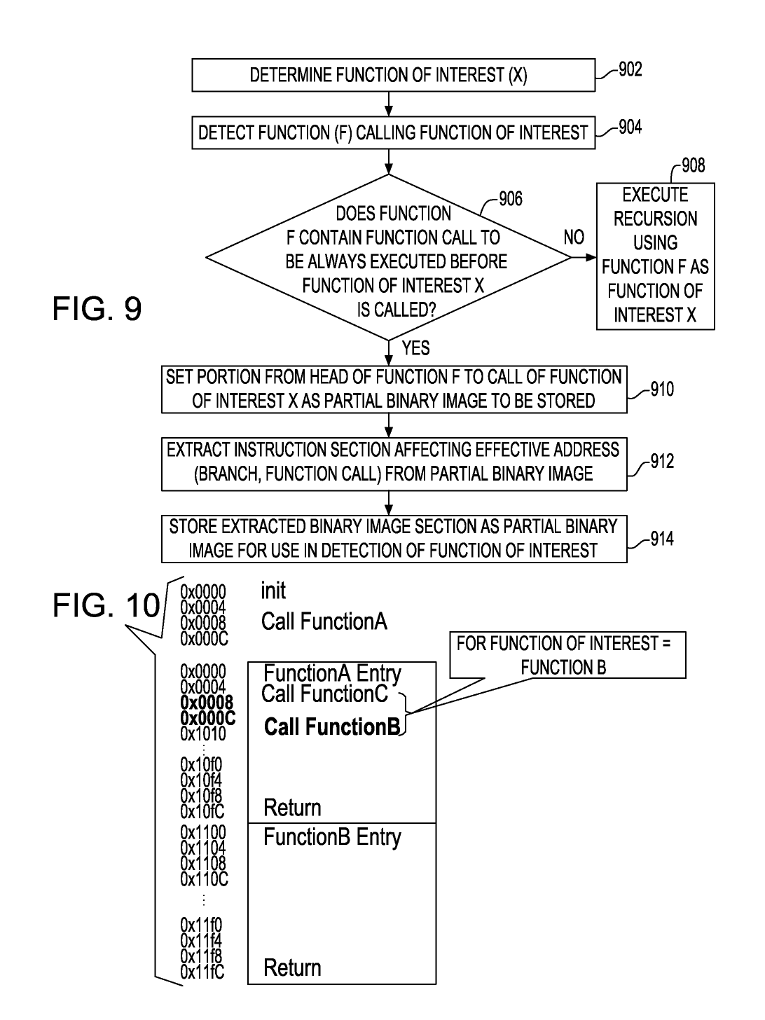

FIG. 9 is a flow diagram illustrating a method of obtaining a partial binary image after a function of interest is determined. At 902, a function of interest, for example, function X, is determined. At 904, another function (F) that calls the function X is detected. If a plurality of functions F exists, the same processing is carried out for each function F. After the detection of at least one function F, it is determined at 906 whether there is a function that is always executed from the start of the function F to execution of the function of interest X. If it is determined that no such a function exists, at 908, recursion is carried out so as to consider the function F itself as the function of interest. If no function calls in F before the function call to X can be found, there are no RETURN instructions executed to return to F before the function call to X. In this case, the exact address within F may not be determined. In order to find the previous RETURN instruction, function F is recursively applied in one embodiment at 908. If it is determined that such a function exists, at 910, a portion between the head of the function F, that is, the start address of function F, to the call of the function X is set as a partial binary image. If there are any function calls in F, this means at least one RETURN instruction will be executed between the start of the function F and the function call to X. Execution of an instruction other than instructions that affect a program counter of the CPU (a branch, a function call) in the partial binary image only advances the program counter to the next instruction. For instance, instructions, such as arithmetic instructions, register operations, load-store, can be omitted from a partial binary image, because they just increment the program counter to the next instruction after the execution. Thus, such an instruction can be omitted for tracing an effective address. Accordingly, only a branch and a function call are extracted from the partial binary image at 912. At 914, extracted binary image section is stored as partial binary image for use in detection of function of interest. Partial binary image, for example, may include image from “the previous function call of function B” to “function B” The measurement device can obtain an effective address required to detect whether the function of interest has been executed in real time.

FIG. 10 illustrates an example of a derived partial binary image when the function of interest is “Function B” in the sample code illustrated in FIG. 4A. In this example, because a function call immediately before a part that calls Function B is “Call Function C”, a portion from the Call Function C to a call point of Function B is included as a partial binary image. Exact address may be generated just before the Function B ends, so program counter can be traced from only the partial binary image. Upon the completion of the execution of Function C and returning from it, a return address (0x1008) is output as trace information. Thereafter, as trace information, information of “Execute” indicating that “0x100C” was executed, and subsequent to this, information of “Execute” indicating that the Call Function B was executed are observed. Because the measurement device has the partial binary image, it can determine that the second “Execute” is an instruction that calls the function of interest of Function B.

One example of C code generated so as to correspond to an executable model produced by Rational Rose RT for use in a model driven design is provided as an example. In this case, tracing the behavior of the model running in the SUT in real time and analyzing it is needed. For the model driven design, trace behavior of a state machine is traced, and the behavior of the state machine can be tracked by measurement of an action at which a state transition occurs. Actions are defined as functions on software. Thus, the behavior of the model can be understood when the start and the termination of a function that corresponds to the action are traced. That is, tracing simply requires measurement of a function corresponding to this specific action.

Action functions on a model are defined as actions occurring in transition between state spaces on the model, and each action function is uniquely defined. In other words, an action function of interest is not called from many different places. For implementation of Rose RT, an action function is called from only one place on a program. Therefore, this is an example that a tracing mechanism provided by the present invention functions very effectively.

The code shown below is an example of code generated by a model actually produced by Rose RT. An action function “chain2_turnOn( )” is set as the unction of interest. In this case, “chain2_turnOn( )” is called from a function of “rtsBehavior ( )” and “getCurrentState( )” is called as a function call immediately before “chain2_turnOn( )” is called. Thus, according to a technique provided by the present disclosure in one embodiment, a measurement device stores the portion of the code existing between “getCurrentState( )” and “chain2_turnOn( )”.

```
void Bulb_Actor::rtsBehavior( int signalIndex, int portIndex )
{
    for( int stateIndex = getCurrentState( ); ;
        stateIndex = rtg_parent_state [ stateIndex − 1 ] )
        switch( stateIndex )
        {
        case 1:
            // {{{RME state ‘:TOP’
            switch( portIndex )
            {
            case 0:
                switch( signalIndex )
                {
                case 1:
                    chain1_Initial( );
                    return;
                default:
                    break;
                }
                break;
            default:
                break;
            }
            unexpectedMessage( );
            return;
            // }}}RME
        case 2:
            // {{{RME state ‘:TOP:Off’
            switch( portIndex )
            {
            case 0:
                switch( signalIndex )
                {
                case 1:
                    return;
                default:
                    break;
                }
                break;
            case 2:
                // {{{RME port ‘electricity’
                switch( signalIndex )
                {
                case Electricity::Conjugate::rti_On:
                    chain2_turnOn( );
                    return;
                default:
                    break;
                }
...
}
```

The amount of code to be stored to observe a specific single function when a model was actually produced by Rose RT was estimated. For example, it was necessary to store a binary image of 44,132 steps when original code is stored without being processed. In contrast, when the technique provided by the present disclosure is used, the amount to be stored is a binary image of only 23 steps, which corresponds to the number of instructions existing between a place where a function to be measured is called and a function call that is always called immediately before the place. In addition, the amount of code to be held in measurement device exclusive of code that does not affect address was 7 steps.

As described above, the technique of the present disclosure obviates the necessity for the measurement device to store all code when a specific function is to be partially observed, and thus, it enables the measurement device to hold only small amount of code.

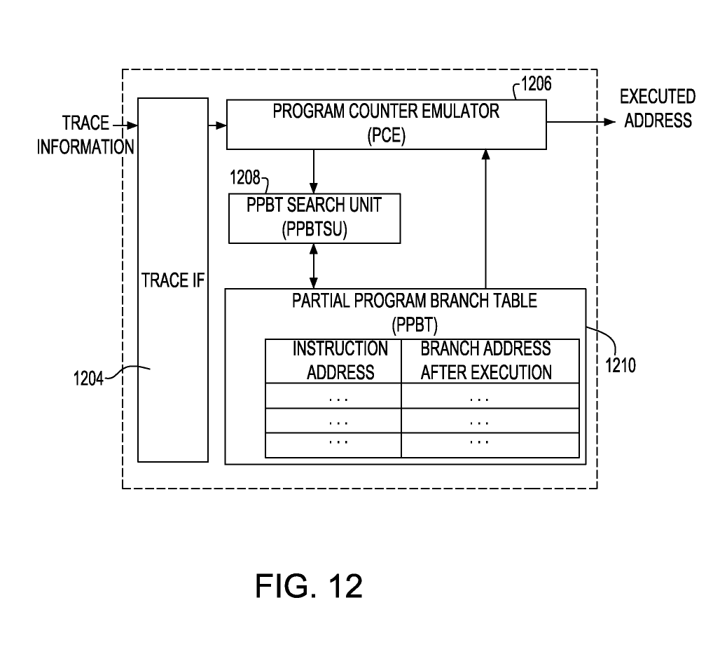

FIG. 12 illustrates a circuit configuration according to the present disclosure in one embodiment. The partial binary image described in the previous section is stored in a partial program branch table (PPBT) 1210. An instruction address in the PPBT 1210 is an address itself where an instruction in the binary image is actually stored. As for a branch instruction after the execution in the PPBT 1210, if the instruction is a branch, a branch address is stored as the branch address after the execution; if the instruction is a function call, an address that calls the function is stored as the branch address after the execution. This PPBT 1210 portion is a portion that can be significantly reduced by the method in one embodiment of the present disclosure.

When trace information is supplied to a circuit, if the trace information 1204 contains address information, the address value is provided to a program counter emulator (PCE) 1206. Trace information has an address value when the CPU executes dynamic branch instruction such as RETURN. The method and system of the present disclosure in one embodiment uses this address value. Otherwise it is determined whether there is an instruction address identical with the current PCE value among the instruction addresses in the PPBT 1210. PPBT search unit 1208 determines if the current PCE value is stored in PPBT. If it is, the unit changes the PCE value to the “Branch address after execution”. Note that the partial program branch table has static branch instructions with its destination address in the partial binary image. The initial PCE value may be unknown. The method and system of the present disclosure in one embodiment gets the valid address value from the previous dynamic branch instruction that is executed before the function call of interest. If no such an identical instruction address is present, the PCE value is incremented by a quantity corresponding to one instruction at the stage when “Execute” is observed as trace information. If such an identical instruction address is found, the PCE value is overwritten with the branch address after the execution when “Execute” or “Branch taken” is observed as trace information. In one embodiment, the circuit of FIGS. 7 and 12 may be similar. Only the memory contents may be different. For instance, the circuit shown in FIG. 7 may store the list of the functions of interest. The circuit shown in FIG. 12 may store the branch information of branch instruction in the partial binary image.

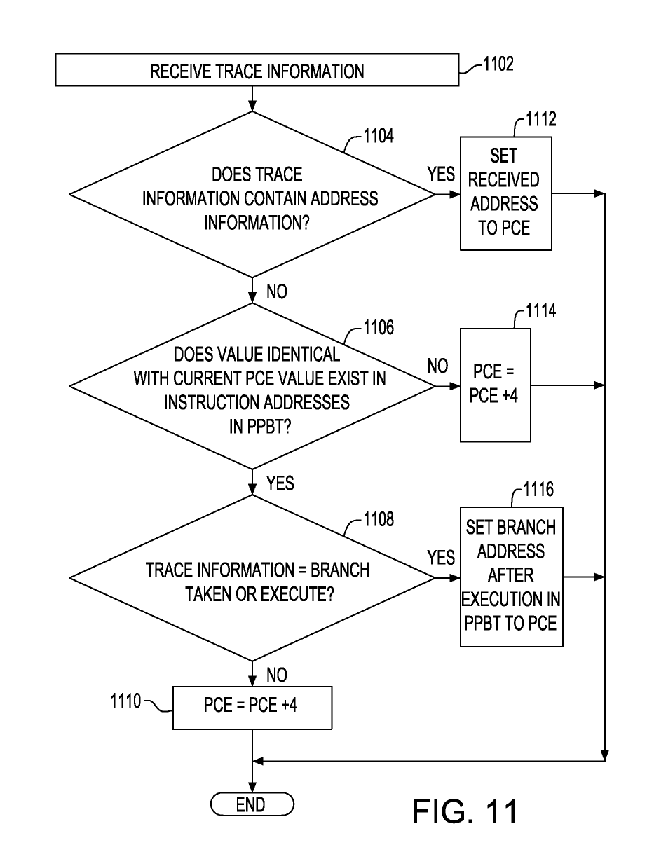

The flow of this processing is shown in FIG. 11 as a flow diagram of processing performed by the circuit. At 1102, trace information is received from a CPU to be monitored by Trace IF (for example, 1204 FIG. 12) At 1104, it is determined whether the trace information contains address information, for instance, PCE (1206 FIG. 12) may perform the determination. If the trace information includes address information, the received address is set to PCE at 1112. Otherwise, at 1106, it is determined whether there exists a value identical to the current PCE value in instruction addresses stored in PPBT. If the CPU is running where it is expected to be, the PCE value will match one of the addresses stored in PPBT. If no identical value is found, the PCE is incremented to the next address at 1114. If the trace information contains no address information, it means the CPU executes static branch instructions or instructions which are unrelated to the program counter. If it is a static branch instruction, PPBT needs to be checked as to whether or not the CPU is executing the instruction desired to be detected. If it is an instruction not related to program counter, the PCE value is increased by 4 to the next address. Otherwise at 1108, if a value is found in PPBT that is identical to the current PCE value, it is determined whether the trace information is equal to the branch taken or executed. If the CPU executes a branch instruction, the trace data is “EXECUTE” or “BRANCH TAKEN”. EXECUTE is generated when the CPU executes an unconditional jump instruction. “BRANCH TAKEN” is generated when the CPU executes a conditional jump instruction and in fact it jumps. If the value equals the branch taken or executed, at 1116, branch address after execution is set in PPBT to PCE. PPBT stores the destination addresses of the static branch instructions. Otherwise, at 1110, PCE is incremented to the next program instruction.

The partial binary image has at least one dynamic branch address call instruction, and it generates the instruction address the CPU executes. The partial binary image also has the branch information on the dynamic branch address call instructions to the functions of interest. By using the partial binary image and trace data, this method enables to detect the functions of interest. As FIGS. 9 to 12 illustrate, the method and system of the present disclosure in one embodiment does not need the whole binary image to determine the actual behavior (i.e., program counter) of the CPU.

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of detecting processor behavior in real time using instruction trace data, comprising:
determining a function of a module executing in a processor to be observed;
identifying one or more call addresses from which the function is called;
establishing one or more end addresses of the function to be a predetermined address increment of said one or more call addresses respectively;
storing said one or more call addresses and said one or more end addresses, receiving instruction trace data; and
comparing a branch address contained in the instruction trace data with said stored one or more call addresses and said one or more end addresses to detect start and end of the function dynamically in real time.

2. The method of claim 1, wherein the step of identifying is performed using static analysis.

3. The method of claim 1, wherein said establishing step includes:
dynamically observing a return address after the function executes; and
dynamically storing the return address as an end address of the function.

4. The method of claim 1, further including:
deriving a partial binary image of a calling function of the function.

5. The method of claim 4, wherein the partial binary image includes instructions traced from the calling function calling the function to said detected end of the function.

6. A circuit device for monitoring processor behavior using instruction trace data, comprising:
a program counter emulator operable to trace current execution address of a processor using trace information and store said current execution address;
a mapping table operable to store information associated with a function to be observed;
a return address table operable to store dynamically a return address of the function during execution; and
a mapping table search unit operable to compare a value in the program counter emulator with one or more values in the mapping table and the return address table to detect start and end of the function, the circuit device operable to output information in real time as to whether the function starts or ends.

7. The circuit device of claim 6, wherein the mapping table stores an identifier of the function and start address of the function.

8. The circuit device of claim 7, wherein the mapping table is set by analyzing a source code before execution.

9. The circuit device of claim 7, wherein the circuit device is operable to output information in real time as to whether the function starts or ends with said identifier.

10. The circuit device of claim 6, wherein the return address table is operable to store return address of the function dynamically when start address of the function is observed in the program counter emulator.

11. The circuit device of claim 6, wherein the stored return address is deleted dynamically when completion of execution of the function is detected.

12. The circuit device of claim 6, wherein the return address of the function is determined as next address of an instruction in a calling function that calls said function.

13. The circuit device of claim 6, wherein the return address is dynamically determined when the function is called.

14. The circuit device of claim 6, wherein the return address is stored dynamically when start of the function is detected in processor execution and the return address is deleted dynamically when end of the function is detected.

15. A circuit device for detecting processor behavior in real time using instruction trace data, comprising:
a program counter emulator operable to trace current execution address of a processor using trace information and store said current execution address;
a partial program branch table operable to store an instruction address and associated branch or function address after an instruction in the instruction address is executed; and
a partial program branch table search unit operable to determine if current execution address is stored in said partial program branch table and to check whether the processor is executing an instruction desired to be detected.
